(19) United States
(12) Patent Application Publication
(10) Pub. No.: US 2007/0059497 A1
(43) Pub. Date: Mar. 15, 2007

(54) Reversal imprint technique

(76) Inventors: Xudong Huang, Singapore (SG); Li-Rong Bao, Bridgewater, NJ (US); Xing Cheng, Ann Arbor, MI (US); Lingjie J. Guo, Ann Arbor, MI (US); Stella W. Pang, Ann Arbor, MI (US)

Correspondence Address: MORRISS O'BRYANT COMPAGNI, P.C., 136 SOUTH MAIN STREET, SUITE 700, SALT LAKE CITY, UT, 84101, US

(21) Appl. No.: 10/513,704

(22) PCT Filed: May 8, 2002
(86) PCT No.: PCT/SG02/00084

§ 371 Date: Nov. 13, 2006

(51) Int. Cl. B05D 5/12; B41M 5/00; B05D 3/12

(52) U.S. Cl. 428/195.1; 427/58; 427/240; 427/355

(57) ABSTRACT

The present invention relates to a method for imprinting a micro-/nano-structure on a substrate, the method comprising (a) providing a mold containing a desired pattern or relief for a microstructure; (b) applying a polymer coating to the mold; and (c) transferring the polymer coating from the mold to a substrate under suitable temperature and pressure conditions to form an imprinted substrate having a desired micro-/nano-structure thereon.

### CROSS REFERENCE TO RELATED APPLICATION

This application claims priority to International Application PCT/SG2002/000084 filed May 8, 2002.

### FIELD OF THE INVENTION

The present invention relates to micro-/nano-scale structures and methods for forming such structures by reversal imprinting.

Statement of the Art

The demand to rapidly and economically fabricate nanoscale structures is a major driving force in the development of nanoscience and nanotechnology. Nanoimprint lithography (NIL), also known as hot embossing lithography, in which a thickness relief is created by deforming a polymer resist through embossing with a patterned hard mold, offers several decisive technical advantages, in particular as a low-cost method to define nanoscale patterns (S. Y. Chou, P. R. Krauss and P. J. Renstrom, Science, 272, 85 (1996) S. Y. Chou, U.S. Pat. No. 5,772,905). It has already been demonstrated that NIL is capable of patterning features with a lateral resolution down to <6 nm (S. Y. Chou, P. R. Krauss, W. Zhang, L. J. Guo and L. Zhuang, J. Vac. Sci. Technol. B, 15, 2897 (1997); S. Y. Chou and P. R. Krauss, Microelectron. Eng., 35, 237 (1997); B. Heidari, I. Maximov and L. Montelius, J. Vac. Sci. Technol. B, 18, 3557 (2000); A. Lebib, Y. Chen, J. Bourneix, F. Carcenac, E. Cambril, L. Couraud and H. Launois, Microelectron. Eng., 46, 319 (1999)). In conventional NIL, a substrate needs to be spin-coated with a polymer layer before it can be embossed with the hard mold. Borzenko et al. reported a bonding process in which both substrate and mold were spin-coated with polymers (T. Borzenko, M. Tormen, G. Schmidt, L. W. Molenkamp and H. Janssen, Appl. Phys. Lett., 79, 2246 (2001)).

Although there are a number of nanoimprinting techniques presently available, these techniques can have one or more of a number of disadvantages. At present, there are strict limitations on the type of substrate that can be used; often only flat hard substrate surfaces can be imprinted. Furthermore, unduly high temperatures and/or pressures are often required which can limit the type of nanostructure produced on many potential substrates.

NIL has already been demonstrated as a high-resolution, high-throughput and low-cost lithography technique. However, to extend the application range of this technique, it is attractive to enable nanoimprinting of three-dimensional structures on non-planar surfaces since they are often desired for complex micro-devices and for new applications. Imprinting overnon-planar surfaces has previously been studied using several techniques that rely on planarization of non-planar surface with thick polymer layer and multilayer resist approaches (X. Sun, L. Zhuang and S. Y. Chou, J. Vac. Sci. Technol. B 16, (1998)). These techniques not only require many process steps, but also involve deep etching to remove the thick planarization polymer layer created during formation, which often degrades the resolution and fidelity of the final pattern or structure formed.

The present inventors have developed a new imprinting technique that is adaptable for many different substrates and substrate configurations. The present invention can be carried out under lower temperatures and pressures than presently used in NIL. The reversal imprinting method according to the present invention offers several unique advantages over conventional NIL by allowing imprinting onto non-planar substrates and substrates that cannot be easily spin-coated with a polymer film, such as flexible polymer substrates. Furthermore, either positive or negative replica of a mold can be fabricated using reversal imprinting by controlling the process conditions.

### BRIEF DESCRIPTION OF THE INVENTION

In a first aspect, the present invention provides a method for imprinting a micro-/nano-structure on a substrate, the method comprising:

(a) providing a mold containing a desired pattern or relief for a micro-/nano-structure;

(b) applying a polymer coating to the mold; and

(c) transferring the polymer coating from the mold to a substrate under suitable temperature and pressure conditions to form an imprinted substrate having a desired micro-/nano-structure thereon.

Preferably the mold is a hard mold formed from the group consisting of semiconductors, dielectrics, metals and their combinations. Typically, the mold is formed in SiO₂ or Si on silicon (Si) wafer and patterned by optical lithography or electron beam lithography and subsequent dry etching. It will be appreciated that other mold types can be used for the present invention.

Polymers suitable for use in the present invention consist of relatively soft materials compared to the mold, including thermoplastic polymers, thermal/irradiative curable prepolymers, and glass or ceramic precursors. Poly(methyl methacrylate) (PMMA) with a molecular weight of at least 15,000 was found to be particularly suitable for the present invention. It will be appreciated, however, that other materials would also be suitable.

In order to assist in the release of the polymer from the mold to the substrate, the mold can be treated with one or more surfactants prior to applying the polymer coating. The surfactant, 1H,1H,2H,2H-perfluorodecyl-trichlorosilane, has been found to be particularly suitable for the present invention. It will be appreciated, however, that other surfactants compatible with the polymer used would also be suitable.

The polymer is preferably applied to the mold by spin coating. Such spin coating application techniques are well known to the art and suitable examples can be found in various conventional lithography techniques. The choice of solvent can be important to achieve a substantially uniform polymer coating on a surfactant coated molds. Polymer solutions in polar solvents usually do not form continuous films on a surfactant-treated mold. The solvent, toluene, has been found to be particularly suitable for the present invention. However, other non-polar solvents compatible with the polymer used would also be suitable. Examples include but are not limited to xylene, and tetrahydrofuran.

Polished Si wafers and flexible polyimide films (Kapton®) were found to be suitable substrates for the present invention. It will be appreciated, however, that other substrates would also be suitable. Examples include but are not limited to polymers, semiconductors, dielectrics, metals and their combinations.

The method of this invention is applicable to planar and non-planar substrates, including substrates which already contain some patterning or relief thereon. The method can be applied to substrates which already contain one or more layers of polymer coating. For instance, the method can be used to create a latticed structure in which multiple layers of polymer (eg polymer gratings) are formed on the substrate.

Step (c) is preferably carried out in a pre-heated hydraulic press under a desired pressure and temperature. The pressure and temperature used will depend on the choice of mold, substrate and polymer. Typically, pressures of less than about 10 MPa are used. A pressure of about 5 MPa or less has been found to be particularly suitable for reversal imprinting PMMA polymer. Temperatures from about 30° C. below to about 90° C. above the glass transition temperature (T_{g}) of the polymer can be used in the present invention.

Depending on the temperature and the degree of planarization of the polymer coating, different imprinting effects can be achieved.

Accordingly, a preferred embodiment of the invention includes a method for imprinting a micro-/nano-structure on a substrate (as described above), wherein the applied polymer coating is substantially non-planar and the temperature is substantially higher than the glass transition temperature (T_{g}) of the polymer. Under these conditions, the behaviour of reversal imprinting is similar to that of conventional NIL in that considerable polymer flow occurs as the polymer material moves in accordance with the shape of the mold. Also, the resultant molded polymer coating is a negative replica of the mold.

According to an alternative embodiment of the invention, the applied polymer coating is substantially non-planar and the temperature is substantially equal to, or below, the glass transition temperature (T_{g}) of the polymer. In this embodiment, it is usual that only the portions of the film which are on the protruding areas of the mold will be transferred to the substrate. In this sense, the method of this embodiment is similar to a stamping process with liquid ink. The method of this embodiment results in the molded polymer coating having a positive replica of the mold.

According to another alternative embodiment of this invention, the applied polymer coating is substantially planar and the temperature is substantially equal to, or below, the glass transition temperature (T_{g}) of the polymer. In this embodiment of the invention, imprinting occurs without any substantial lateral polymer movements and the entire coated polymer layer is transferred to the substrate. Under this embodiment of the invention, the resultant molded polymer coating is a negative replica of the mold. In this embodiment in which the whole polymer coating is transferred to the substrate, a further benefit is that low residue thickness is achieved.

The method of this invention can be performed several times using the same substrate, so that a layered structure having multiple polymer layers can be formed. For example, each polymer layer may contain a number of parallel strips (ie forming a grid pattern) which are transverse (eg at right angles to) the parallel strips of an adjoining polymer layer. The resulting structure will thereby have a lattice formation.

In a second aspect, the present invention provides a substrate containing an imprinted micro-/nano-structure produced by the method according to the first aspect of the present invention. This micro-/nano-structure may be formed of a single imprinted polymer layer. Alternatively, it may be formed of a number of polymer layers resulting in a relatively complex 3-D structure, such as a latticed structure.

The micro-/nano-structure is suitable for use in lithography, integrated circuits, quantum magnetic storage devices, lasers, biosensors, photosensors, microelectromechanical systems (MEMS), bio-MEMS and molecular electronics.

In a third aspect, the present invention provides use of the method according to the first aspect of present invention to form a micro-/nano-structure on a non-planar or flexible substrate.

Throughout this specification, unless the context requires otherwise, the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed before the priority date of each claim of this application.

In order that the present invention may be more clearly understood, preferred forms will be described with reference to the following drawings and examples.

### BRIEF DESCRIPTION OF THE DRAWINGS

FIG. 1 shows schematic illustrations of pattern transfer processes in (a) conventional nanoimprinting; (b) reversal imprinting at temperatures well above T_{g}; (c) “inking” at temperatures around transition glass temperature (T_{g}) with non-planar mold; (d) “whole-layer transfer” around T_{g} with planarized mold.

FIG. 2 shows an Atomic Force Microcopy (AFM) section analysis of a 300 nm deep grating mode coated with 6% PMMA solution at 3000 rpm.

FIG. 3 shows average peak-to-valley step height in grating molds with different depths after spin-coating with different solutions at 3000 rpm. Regions of different pattern transfer modes at 105° C. are specified, with the dotted lines indicating the transition region between the two modes.

FIG. 4 shows dependence of reversal imprinting modes on imprinting temperature and step height of the coated mold. The symbols are experimental data and the solid lines are extrapolated boundaries for different modes.

FIG. 5 shows a scanning electron micrography of the result of reversal imprinting at 105° C. using a 350 nm deep grating mold with 7% PMMA coating. The Rₘₐₓ before imprinting was 75 nm and the whole-layer transfer mode occurred.

FIG. 6 shows a scanning electron micrography of the result of inking at 105° C. with a 650 nm deep grating mold, 6% coating and Rₘₐₓ=305 nm.

FIG. 7 shows a scanning electron micrography of the patterns in PMMA created by reversal imprinting at 175° C. on a 50 μm thick Kapton film. The 350 nm deep mold was spin-coated with a 7% solution.

FIG. 8 shows a schematic of imprinting over a structured surface using the present invention: (a) PMMA spin-coated on a mold prior to coating on a patterned substrate; (b) printing onto patterned structure at a temperature below T_{g}; (c) PMMA pattern transferred onto substrate.

FIG. 9 shows a scanning electron micrograph (SEM) micrograph of printed PMMA grating perpendicular to a patterned 1.5 μm deep channeled SiO₂ substrate surface: (a) viewing along the transferred PMMA grating; (b) viewing along the underlying SiO₂ grating pattern on the substrate.

FIG. 10 shows a SEM micrograph of PMMA grating transferred onto a patterned substrate at 175° C. where dewetting has removed the residual PMMA layer.

### DESCRIPTION OF THE ILLUSTRATED EMBODIMENTS

Experimental

Two kinds of patterned molds were used in our study. The molds were made in SiO₂ on silicon (Si) wafer and patterned by optical lithography and subsequent dry etching. One mold had features varying from 2 to 50 μm and a nominal depth of 190 nm. The other mold had uniform gratings with a 700 nm period and a depth ranging from 180 to 650 nm. All molds were treated with an surfactant, 1H,1H,2H,2H-perfluorodecyl-trichlorosilane, to promote polymer release. The substrates used were polished (100) Si wafers and flexible, 50 μm thick polyimide films (Kapton®). Poly(methyl methacrylate) (PMMA) with a molecular weight of 15,000 was used for imprinting. In a typical reversal imprinting experiment, a mold was spin coated with a PMMA toluene solution at a spin rate of 3,000 rpm for 30 seconds and then heated at 105° C. for 5 min to remove residual solvent. The coated mold was pressed against a substrate in a pre-heated hydraulic press under a pressure of 5 MPa for 5 min. The pressure was sustained until the temperature fell below 50° C. Finally the mold and the substrate were demounted and separated.

Results and Discussion

In conventional NIL, a polymer film needs to be spin-coated on the substrate before it can be imprinted by a hard mold. However, spin-coating is rather difficult on flexible substrates such as polymer membranes, which limits the capability of conventional NIL in patterning such substrates. Furthermore, as conventional NIL relies on viscous polymer flow to deform the polymer film and create the thickness contrast, elevated temperature and pressure are required (L. J. Heyderman, H. Schift, C. David, J. Gobrecht and T. Schweizer, Microelectron. Eng., 54, 229 (2000); H. C. Scheer, H. Schulz, T. Hoffmann and C. M. S. Torres, J. Vac. Sci. Technol. B, 16, 3917 (1998); S. Zankovych, T. Hoffmann, J. Seekamp, J. U. Bruch and C. M. S. Torres, Nanotechnology, 12, 91 (2001)). To achieve reliable pattern transfer, imprinting is typically performed at temperatures between 70 to 90° C. above T_{g} (glass transition temperature) and under pressures as high as 10 MPa (L. J. Heyderman, H. Schift, C. David, J. Gobrecht and T. Schweizer, Microelectron. Eng., 54, 229 (2000); H. C. Scheer, H. Schulz, T. Hoffmann and C. M. S. Torres, J. Vac. Sci. Technol. B, 16, 3917 (1998); F. Gottschalch, T. Hoffmann, C. M. S. Torres, H. Schulz and H. Scheer, Solid-State Electron., 43, 1079 (1999)). Certain modifications to the conventional NIL technique such as the polymer bonding method developed by Borzenko et al. (T. Borzenko, M. Tormen, G. Schmidt, L. W. Molenkamp and H. Janssen, Appl. Phys. Lett., 79, 2246 (2001)) considerably reduce the temperature and pressure requirements. However, the polymer bonding method of Borzenko et al. suffers the additional disadvantage of thick residue layer after imprinting, which complicates subsequent pattern transfer.

Different from conventional NIL, the reversal imprinting technique according to the present invention is a convenient and reliable method to pattern flexible substrates. Furthermore, depending on the degree of planarization of the polymer-coated mold and the imprinting temperature, three distinct pattern transfer modes can be observed. Successful and reliable pattern transfer can be achieved at temperatures as low as about 30° C. below T_{g} and pressures of less than about 1 MPa.

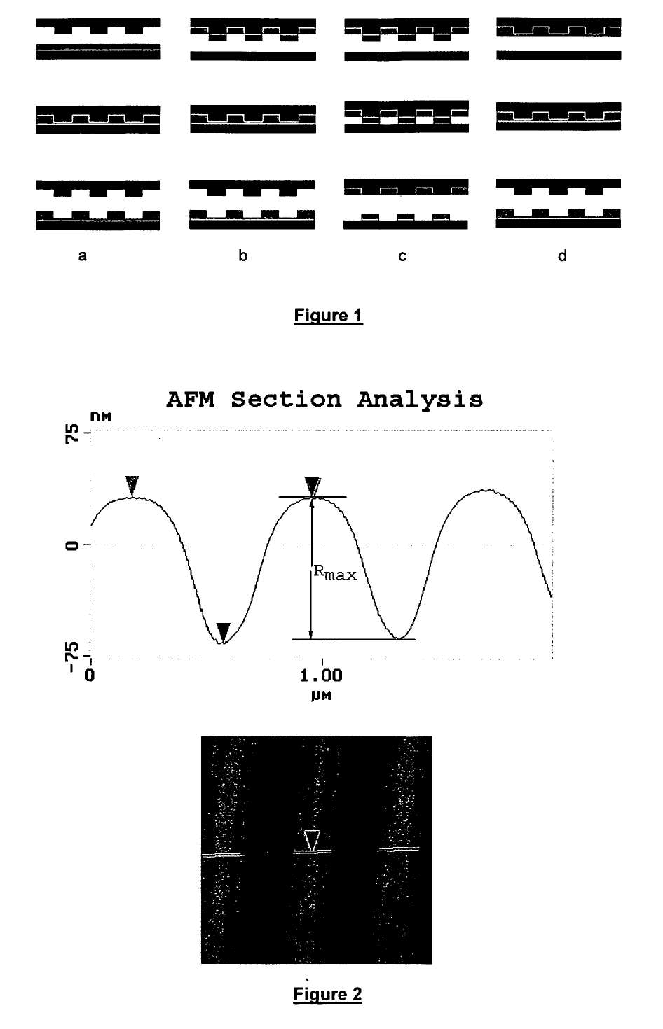

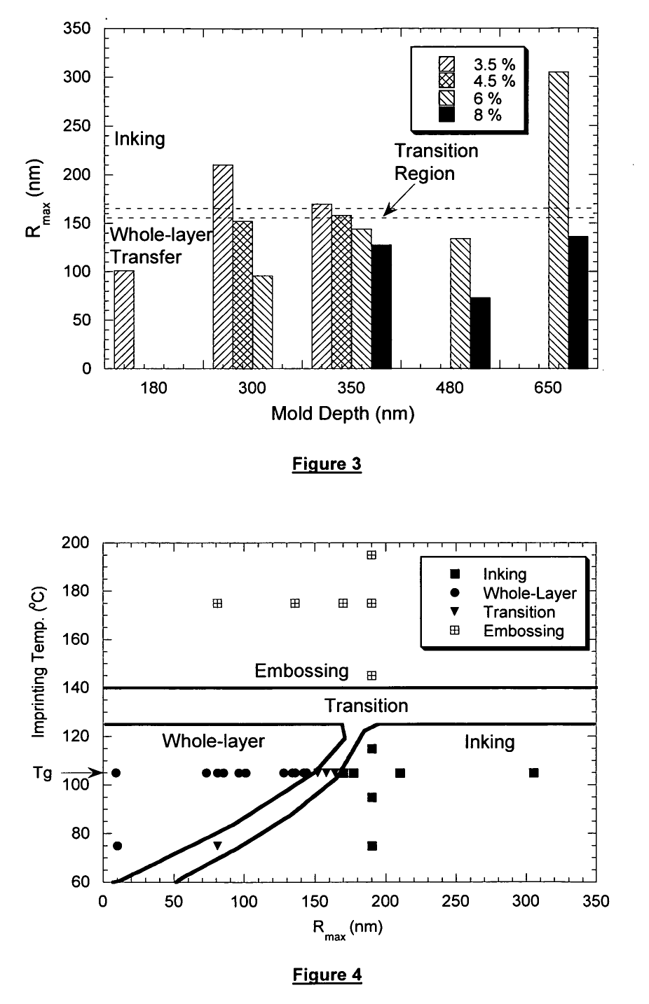

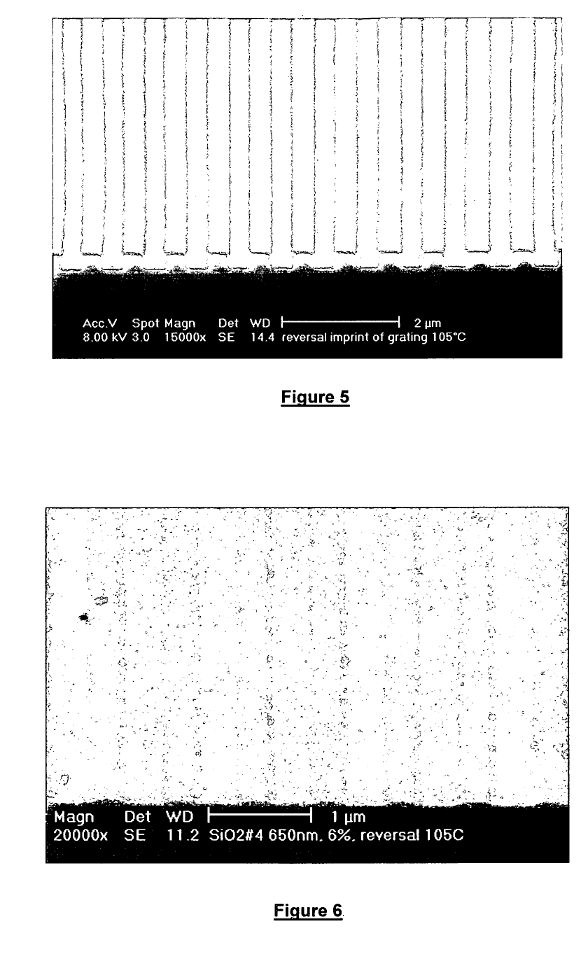

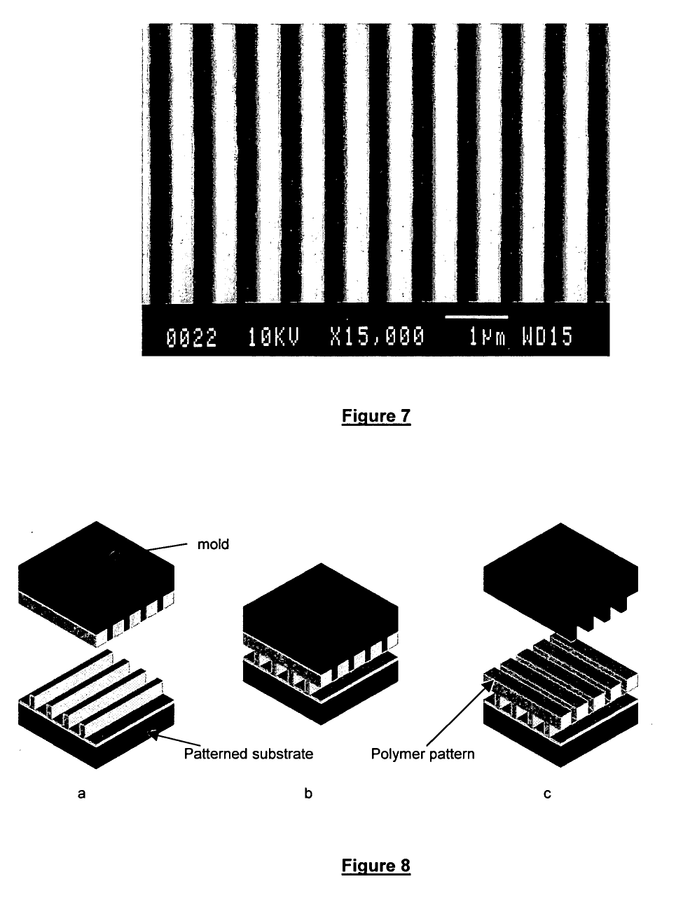

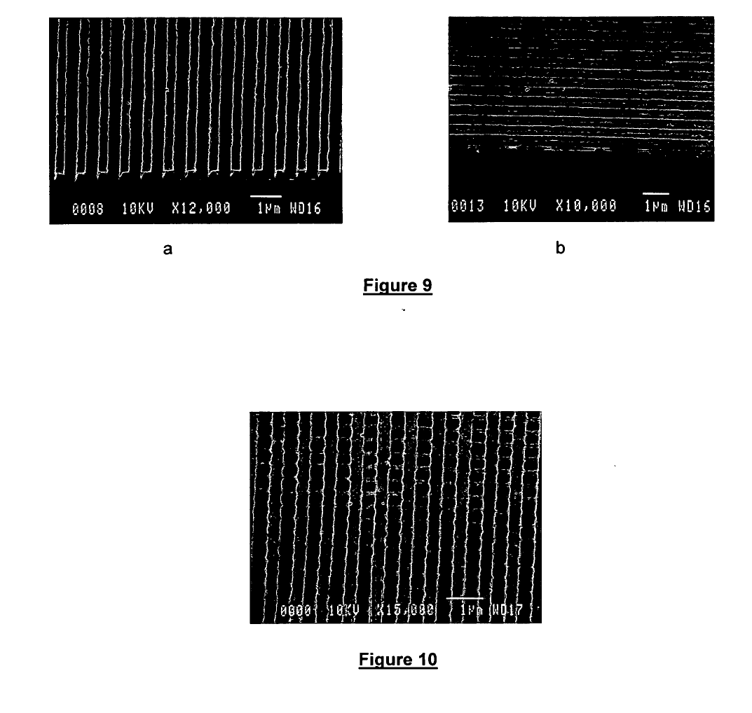

FIG. 1 schematically illustrates the three reversal imprinting modes in comparison with the conventional NIL. In conventional NIL (FIG. 1(a)), the mold is pressed against a flat polymer film at a temperature well above T_{g}. During imprinting, considerable polymer flow occurs as the material deforms in accordance to the shape of the mold. At temperatures well above T_{g}, similar polymer flow can also occur in reversal imprinting. Even if the polymer film is not planarized as shown in FIG. 1(b), the material on the protruding areas of the mold can be squeezed into surrounding cavities during imprinting. Under such conditions, the behaviour of reversal imprinting is very similar to that of conventional NIL. As the underlining mechanism for imprinting in this situation is the viscous flow of the polymer, we term this imprinting mode as “embossing”.

A distinct advantage of reversal imprinting over conventional imprinting is that patterns can also be transferred to the substrate at temperatures around or even slightly lower than T_{g}. Within this temperature range, the imprinting result is significantly dependent on the degree of planarization after spin-coating the mold. For molds with non-planarized coating, only the film on the protruding areas of the mold will be transferred to the substrate as illustrated in FIG. 1(c). As this process is similar to a stamping process with liquid ink, this imprinting mode is termed “inking”. Contrary to the embossing mode, in which a negative replica of the mold is produced on the substrate, inking results in a positive pattern.

If, however, the coated polymer film is somewhat planar after spin-coating, the entire coated polymer film can be transferred to the substrate without large scale lateral polymer movements during imprinting around T_{g} (FIG. 1(d)). We call this imprinting mode “whole-layer transfer”. Similar to the embossing mode, the whole-layer transfer mode also results in a negative replica of the mold.

From the discussion above, it is clear that the degree of surface planarization of the coated polymer film and the imprinting temperature are important factors in determining the final imprinting result. In the sections below, the quantitative correlation between imprinting conditions and final results are discussed.

Surface Planarization after Spin-Coating

It is generally adopted in conventional NIL to treat molds with an anti-adhesion agent to promote polymer release in separation. It is also preferable to modify the surface energy of the molds in reversal imprinting in order to promote transferring the polymer layer to the substrate. 1H,1H,2H,2H-perfluorodecyltrichlorosilane, a release coating in conventional imprinting, (T. Nishino, M. Meguro, K. Nakamae, M. Matsushita and Y. Ueda, Langmuir, 15, 4321 (1999)), was used as the release agent in our study. However, a technique for spin-coating PMMA onto an anti-adhesive treated mold needed to be developed. Because of the low surface energy of the treated mold, PMMA solution in polar solvents, such as chlorobenzene, will not form continuous films after spin-coating. In contrast, PMMA solution in toluene can be successfully spin-coated onto the surfactant treated molds. Spin-coating of PMMA toluene solution onto a surfactant-treated surface gave similar film quality and thickness to an untreated surface.

Due to the topology of a typical mold, it is necessary to investigate the degree of planarization of the spin-coated polymer layer. For molds with larger feature size, obtaining a planarized polymer coating is more difficult. Under usual conditions, spin-coating the 190 nm deep mold with micrometer-sized features often results in conformal coating on the mold. In the case of the sub-micrometer grating mold, the degree of planarization is a strong function of the concentration of the solution used for spin-coating, which determines the thickness of the coated film. A typical Atomic Force Microcopy (AFM) section analysis of the coated mold is shown in FIG. 2. After spin-coating, the step height of the coated mold depended both on the mold depth and film thickness. As shown in FIG. 2, we characterized the degree of planarization by the average peak-to-valley height of the coated mold, Rₘₐₓ. FIG. 3 summarizes the change in Rₘₐₓ as a function of solution concentration in grating molds with different depths. For a given feature depth, a higher solution concentration gives a thicker film and results in a lower Rₘₐₓ, or higher degree of planarization.

The different degrees of planarization in FIG. 3 have been correlated with the final imprinting result. At an imprinting temperature of 105° C., which is the same as the T_{g} of PMMA, when Rₘₐₓ is below −155 nm, whole-layer transfer mode occurs, while the inking mode occurs with Rₘₐₓ above ˜168 nm. For Rₘₐₓ between 155 and 168 nm, a combination of these two modes may occur. The regions of different imprinting modes at 105° C. are indicated in FIG. 3.

Different Modes of Reversal Imprinting

When the two important imprinting parameters, i.e., degree of planarization and imprinting temperature are both considered, a map of the imprinting modes can be constructed as shown in FIG. 4. The symbols represent experimental data with different molds and different film thicknesses. The three main regions define the necessary conditions for the occurrence of each imprinting mode. In the transition region, the combination of two or more modes can occur. While conventional NIL is usually only successful at temperatures well above T_{g}, reversal imprinting according to the present invention can be used in a wide temperature range below and above T_{g}. We have demonstrated the occurrence of inking and whole-layer transfer at temperatures as low as 75° C., which is 30° C. lower than the T_{g} of PMMA.

FIG. 4 indicates that at 105° C., whole-layer transfer will occur when Rₘₐₓ is lower than about 155 nm. An example of such imprinted patterns is shown in FIG. 5. Faithful pattern transfer with very few defects can be achieved. An important feature of the whole-layer transfer mode is the low residue thickness (well below 100 nm in FIG. 5). When solutions with the same concentration are used, the residue thickness after reversal imprinting at a temperature around T_{g} is comparable to conventional NIL at a much higher temperature. Furthermore, reliable whole-layer transfer has also been achieved with pressure as low as 1 MPa.

While the whole-layer transfer mode requires adequate surface planarization of the coated mold, larger step height after coating is advantageous to successful inking. This is because when the step height is small, the film on the sidewalls of the features is usually relatively thick. When such a film is inked, the tearing of the polymer film near the sidewalls will result in ragged edges of the printed features. FIG. 6 shows the inking result at 105° C. with a step height of 305 nm. Such a large step height is formed by coating a 650 nm deep grating mold with a relatively thin coating (6% solution). Under such conditions, the film on the sidewalls of the recessed features on the mold is extremely thin and will easily break during imprinting. As a result, reliable pattern transfer with relatively smooth edges can be obtained.

Reversal Imprinting PMMA onto a Flexible Substrate

In a reversal imprinting process, there is no need to spin coat a polymer layer onto the substrate. This unique feature makes it possible to create patterns on some substrates that cannot be easily spin-coated, for example, flexible polymer substrates. We have successfully employed this reversal nanoimprinting technique to transfer PMMA patterns onto a 50 μm thick polyimide film (Kapton®), which is widely used as substrates for flexible circuits. FIG. 7 shows PMMA patterns created by reversal imprinting at 175° C. after spin-coating a 350 nm deep grating mold with a 7% solution. The imprints on the flexible substrate show high uniformity over the entire imprinted area (˜2.5 cm²) with few defects. The particular result shown in FIG. 7 is imprinted under the embossing mode. Inking and whole-layer transfer modes also occur on the flexible substrate and the imprinting results are similar to those obtained on Si substrate.

Reversal Imprinting PMMA onto a Patterned Substrate

The present invention can be used to facilitate nanoimprinting on non-planar surfaces, without the need for planarization. Previously, techniques for nanoimprint lithography over non-planar surfaces have generally relied on planarization of the non-planar surface with a thick polymer layer and multilayer resist approaches. These techniques require numerous steps and involve deep etching to remove the thick planarization polymer layer (which can degrade the resolution and fidelity in imprinting lithography). The present invention can be used to facilitate nanoimprinting on non-planar surfaces, without any planarization.

FIG. 8 shows a schematic of imprinting over a structured surface using the present invention. FIG. 8(a) shows PMMA spin-coated on a mold prior to coating on a patterned substrate. The coated mold is then applied to the patterned structure (FIG. 8(b)) under appropriate temperature and pressure conditions. When the mold was released, the substrate had a polymer pattern attached to the existing patterned substrate.

FIG. 9 shows polymer patterns transferred onto a non-planar substrate. The substrate is an SiO₂ grating with 700 nm period and has a depth of 1.5 μm. The mold also has a grating pattern with the same period and a depth of 350 nm, and is coated with a surfactant. PMMA was spun-coated on the mold and was pressed against the patterned substrate with a pressure of 5 MPa at 90° C. The whole PMMA layer with the molded grating pattern was transferred onto the substrate because the adhesion of PMMA to the substrate is much stronger than that to the mold due to the large difference in surface energy at the interfaces. Good pattern transfer is observed, and the residual PMMA is very thin as shown in SEM micrographs taken at two different angles (FIG. 9). It is straight-forward to remove any thin residual PMMA layer by a O₂ RIE process as used in typical nanoimprint lithography.

The method shown in FIG. 9 can be repeated several times, thereby resulting in a multi-layered structure. Each sequential layer of the polymer (which contains the molded grating pattern) can be applied at right-angles to the previous layer. This forms a multi-layer latticed structure.

Whereas FIG. 9 shows the patterned polymer layer being applied so that the gratings are at right angles to the gratings on the substrate, it is also possible to have the polymer gratings applied onto and in alignment with the gratings on the substrate. This would enable the depth of the gratings to be varied (ie increased) as desired.

If the temperature at which the printing of PMMA coated mold onto the grating substrate is raised to 175° C., the residual layer disappears (FIG. 10). This could be due to the polymer dewetting behaviour on a surfactant coated surface.

This polymer printing technique solved the problem encountered in nanoimprint lithography over non-planar surfaces. This technique can be extended to create various three-dimensional structures.

We have successfully demonstrated a reversal imprint process by transferring a spin-coated polymer layer from the hard mold to the substrate. Three different pattern transfer modes, i.e., embossing, inking and whole-layer transfer, can be accomplished by controlling imprinting temperature and degree of surface planarization of the spin-coated mold. Either a positive or negative replica of the mold can be obtained after imprinting. With a suitable degree of surface planarization, successful pattern transfer can be achieved at temperatures and pressures as low as 30° C. below T_{g} and 1 MPa, respectively, in the inking and whole-layer transfer modes. This is a significant advantage over the conventional NIL, which requires an imprinting temperature well above T_{g}. Moreover, as little movement of the polymer is required in these two pattern transfer modes, reversal imprinting is less sensitive to problems associated with polymer flow.

The present inventors have developed a new imprinting technique that avoids the need to spin-coat polymer layers on the substrate. A polymer layer was spin-coated directly on a mold, and transferred to a substrate by imprinting under suitable temperature and pressure conditions. The reversal imprinting method according to the present invention offers a unique advantage over conventional NIL by allowing imprinting onto substrates that cannot be easily spin-coated with a polymer film, such as flexible polymer substrates.

Previous efforts to apply NIL to non-planar substrate often rely on planarization of the non-planar surfaces with a thick polymer layer. These techniques involve multiple process steps. Furthermore, the deep etching step to remove the thick planarization layer degrades the resolution and fidelity. The current invention offers a simple technique to pattern over a non-planar surface without the need for a planarization procedure. Under suitable process conditions, three-dimensional structures can be conveniently fabricated.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. A method for imprinting a micro-/nano-structure on a substrate, the method comprising:
(a) providing a mold containing a desired pattern or relief for a micro-/nano-structure;
(b) applying a polymer coating to the mold; and
(c) transferring the polymer coating from the mold to a substrate under suitable temperature and pressure conditions to form an imprinted substrate having a desired micro-/nano-structure thereon, wherein the micro-/nano-structure is a negative replica of the pattern on the mold.

2. The method according to claim 1 wherein the mold is formed from the group consisting of semiconductors, dielectrics, metals, and combinations thereof.

3. The method according to claim 2 wherein the mold is patterned by optical lithography or electron beam lithography and subsequent dry etching.

4. The method according to claim 1 wherein the polymer coating is selected from the group consisting of thermoplastic polymers, thermal/irradiative curing prepolymers, and glass or ceramic precursors.

5. The method according to claim 4 wherein the polymer coating is formed of poly(methyl methacrylate) (PMMA).

6. The method according to claim 1 wherein the polymer coating is formed from a polymer in a solution of a non-polar solvent to achieve a substantially uniform polymer coating on the mold.

7. The method according to claim 6 wherein the solvent is selected from the group consisting of toluene, xylene, and tetrahydrofuran.

8. The method according to claim 7 wherein the solvent is toluene.

9. The method according to claim 1 wherein the polymer is applied to the mold by spin coating.

10. The method according to any one of claims claim 1 wherein the mold is treated with one or more surfactants prior to applying the polymer coating.

11. The method according to claim 10 wherein the surfactant is 1H,1H,2H,2H-perfluorodecyl-trichlorosilane.

12. The method according to claim 1 wherein the substrate is selected from the group consisting of polymers, semiconductors, dielectrics, silicon components, metals, and combinations thereof.

13. The method according to claim 12 wherein the substrate is a silicon wafer.

14. The method according to claim 12 wherein the substrate has one or more patterned structures on the surface.

15. The method according to claim 12 wherein the substrate is a flexible polymer film, such as polyimide or polyester.

16. The method according to claim 1 wherein step (c) is carried out in a heated hydraulic press under a desired pressure and temperature.

17. The method according to claim 16 wherein the pressure is less than about 5 MPa.

18. The method according to claim 16 wherein the pressure is from about 1 MPa to about 5 MPa.

19. The method according to claim 1 wherein the temperature is from about 30° C. below the glass transition temperature (T_{g}) of the polymer to about 90° C. above the T_{g} of the polymer.

20. The method according to claim 19, wherein the applied polymer coating is substantially non-planar and the temperature is substantially higher than the glass transition temperature (T_{g}) of the polymer.

21. The method according to claim 20, wherein the temperature is about 90° C. above the glass transition temperature (T_{g}) of the polymer.

22. (canceled)

23. The method according to claim 19, wherein the applied polymer coating is substantially planar and the temperature is substantially equal to, or below, the glass transition temperature (T_{g}) of the polymer.

24. The method according to claim 19 wherein the temperature is at about the glass transition temperature (T_{g}) of the polymer.

25. The method according to claim 19 wherein the temperature is about 30° C. below the glass transition temperature (T_{g}) of the polymer.

26-33. (canceled)

34. A substrate containing an imprinted micro-/nano-structure produced by the method, comprising:
(a) providing a mold containing a desired pattern or relief for a micro-/nano-structure;
(b) applying a polymer coating to the mold; and
(c) transferring the polymer coating from the mold to a substrate under suitable temperature and pressure conditions to form an imprinted substrate having a desired micro-/nano-structure thereon, wherein the micro-/nano-structure is a negative replica of the pattern on the mold.

35. The substrate of claim 35 wherein the imprinted structure is a negative replica of the mold.

36. (canceled)

37. The substrate of claim 34 wherein the polymer coating is substantially non-planar and the temperature is substantially equal to, or below, the glass transition temperature (T_{g}) of the polymer and the imprinted structure is a negative replica of the mold.

38. (canceled)

39. A method for imprinting a micro-/nano-structure on a substrate, the method comprising:
(a) providing a mold containing a desired pattern or relief for a micro-/nano-structure;
(b) applying a polymer coating to the mold by spin coating; and
(c) transferring the polymer coating from the mold to a substrate under suitable temperature and pressure conditions to form an imprinted substrate having a desired micro-/nano-structure thereon, wherein the micro-/nano-structure is a positive replica of the pattern on the mold.

40. The method according to claim 39 wherein the mold is formed from the group consisting of semiconductors, dielectrics, metals, and combinations thereof.

41. The method according to claim 40 wherein the mold is patterned by optical lithography or electron beam lithography and subsequent dry etching.

42. The method according to claim 39 wherein the polymer is selected from the group consisting of thermoplastic polymers, thermal/irradiative curing prepolymers, and glass or ceramic precursors.

43. The method according to claim 42 wherein the polymer is poly(methyl methacrylate) (PMMA).

44. The method according to claim 39 wherein the polymer is in a solution of a non-polar solvent to achieve a substantially uniform polymer coating on the mold.

45. The method according to claim 44 wherein the solvent is selected from the group consisting of toluene, xylene, and tetrahydrofuran.

46. The method according to claim 45 wherein the solvent is toluene.

47. The method according to claim 39 wherein the mold is treated with one or more surfactants prior to applying the polymer coating.

48. The method according to claim 47 wherein the surfactant is 1H,1H,2H,2H-perfluorodecyl-trichlorosilane.

49. The method according to claim 39 wherein the substrate is selected from the group consisting of polymers, semiconductors, dielectrics, silicon components, metals, and combinations thereof.

50. The method according to claim 49 wherein the substrate is a silicon wafer.

51. The method according to claim 49 wherein the substrate has one or more patterned structures on the surface.

52. The method according to claim 49 wherein the substrate is a flexible polymer film, such as polyimide or polyester.

53. The method according to claim 49 wherein step (c) is carried out in a heated hydraulic press under a desired pressure and temperature.

54. The method according to claim 53 wherein the pressure is less than about 5 MPa.

55. The method according to claim 53 wherein the pressure is from about 1 MPa to about 5 MPa.

56. The method according to claim 39 wherein the temperature is from about 30° C. below the glass transition temperature (T_{g}) of the polymer to about 90° C. above the T_{g} of the polymer.

57. The method according to claim 56, wherein the applied polymer coating is substantially non-planar and the temperature is substantially equal to, or below, the glass transition temperature (T_{g}) of the polymer.

58. The method according to claim 56 wherein the temperature is at about the glass transition temperature (T_{g}) of the polymer.

59. The method according to claim 56 wherein the temperature is about 30° C. below the glass transition temperature (T_{g}) of the polymer.

60. The method according to claim 56, wherein the substrate is non-planar and the temperature is lower than the glass transition temperature (Tg) of the polymer.

61. The method according to claim 60, wherein the non-planar substrate includes a grating pattern thereon.

62. The method according to claim 61, wherein the desired pattern or relief of the mold is a grating pattern.

63. The method according to claim 62, wherein the grating pattern on the substrate has a period of about 700 nm and a depth of about 1.5 μm, and the grating pattern on the mold has a period of about 700 nm and a depth of about 350 nm.

64. The method according to claim 63, wherein the polymer coating is transferred from the mold to the substrate at a temperature of about 90° C. and a pressure of about 5 MPa.

65. The method according to claim 62, wherein the polymer coating is transferred to the substrate so that the grating pattern of the substrate is transverse to the grating pattern of the polymer coating.

66. The method according to claim 62, wherein the polymer coating is transferred to the substrate so that the grating pattern of the substrate and the grating pattern of the polymer coating are in alignment.

67. The method according to claim 65, wherein steps b) and c) are repeated one or more times so as to form a latticed structure.

68. A substrate containing an imprinted micro-/nano-structure produced by the method comprising:
(a) providing a mold containing a desired pattern or relief for a micro-/nano-structure;
(b) applying a polymer coating to the mold by spin coating; and
(c) transferring the polymer coating from the mold to a substrate under suitable temperature and pressure conditions to form an imprinted substrate having a desired micro-/nano-structure thereon, wherein the micro-/nano-structure is a positive replica of the pattern on the mold.

69. The substrate according to claim 68 wherein the imprinted structure is a positive replica of the mold.
